(19) United States
(12) Patent Application Publication
(10) Pub. No.: US 2026/0197043 A1
(43) Pub. Date: Jul. 9, 2026

(54) METHOD FOR DETERMINING PRECODING CODEBOOK AND COMMUNICATION DEVICE

(71) Applicant: Beijing Xiaomi Mobile Software Co., Ltd., Beijing (CN)

(72) Inventors: Liangang CHI, Beijing (CN); Li YANG, Beijing (CN)

(21) Appl. No.: 19/131,467

(22) PCT Filed: Nov. 22, 2022
(86) PCT No.: PCT/CN2022/133581

§ 371 Date: May 20, 2025

(51) Int. Cl. H04B 7/0456

(52) U.S. Cl. CPC H04B 7/0456

(57) ABSTRACT

A method for determining a precoding codebook includes a network device determining a first codebook for data transmission according to channel information of at least one terminal, and sending first codebook information of the first codebook to the terminal.

### CROSS-REFERENCE TO RELATED APPLICATIONS

The present application is a U.S. National Stage of International Application No. PCT/CN2022/133581, filed on Nov. 22, 2022, the contents of all of which are incorporated herein by reference in their entirety for all purposes.

### BACKGROUND OF THE INVENTION

A multiple input multiple output (MIMO) technology can improve data throughput and link range without increasing bandwidth or transmission power, and thus has attracted a wide attention in the industry. In a MIMO system, the performance of a codebook-based precoding technology is closely related to the design of a codebook.

### SUMMARY OF THE INVENTION

The present disclosure relates to the technical field of wireless communication, in particular to a method for determining a precoding codebook and communication device.

A method for determining a precoding codebook is provided in a first aspect of embodiments of the present disclosure. The method is performed by a network device, including:
determining a first codebook for data transmission, where the first codebook is generated based on channel information of at least one terminal; and
sending the first codebook information of the first codebook to the at least one terminal.

A method for determining the precoding codebook is provided in a second aspect of the embodiments of the present disclosure. The method is performed by a terminal, including:
receiving first codebook information sent by a network device, where the first codebook information is codebook information of a first codebook for data transmission, and the first codebook is generated based on channel information of at least one terminal.

A communication device is provided in a third aspect of the embodiments of the present disclosure, including:
a memory that stores a computer program;
one or more processors,
where the computer program, when collectively executed by the one or more processors, causes the communication device to:
receive first codebook information sent by a network device, where the first codebook information is codebook information of a first codebook for data transmission, and the first codebook is generated based on channel information of at least one terminal.

A communication device is provided in a fourth aspect of the embodiments of the present disclosure, including:
a memory that stores a computer program;
one or more processors,
where the computer program, when collectively executed by the one or more processors, causes the communication device to perform the method according to the first aspect of the embodiments of the present disclosure.

Additional aspects and benefits of the present disclosure will be given in part in the description below, and in part will become apparent from the description below, or be learned through practice of the present disclosure.

### BRIEF DESCRIPTION OF DRAWINGS

The above and/or additional aspects and benefits of the present disclosure will become apparent and are easily understood from the following description of embodiments in conjunction with the accompanying drawings, where:

FIG. 1 is a schematic flowchart of a method for determining a precoding codebook according to an embodiment of the present disclosure;

FIG. 2 is a schematic flowchart of a method for determining the precoding codebook according to an embodiment of the present disclosure;

FIG. 3 is a schematic flowchart of a method for determining the precoding codebook according to an embodiment of the present disclosure;

FIG. 4 is a schematic flowchart of a method for determining the precoding codebook according to an embodiment of the present disclosure;

FIG. 5 is a schematic flowchart of a method for determining the precoding codebook according to an embodiment of the present disclosure;

FIG. 6 is a schematic flowchart of a method for determining the precoding codebook according to an embodiment of the present disclosure;

FIG. 7 is a schematic flowchart of a method for determining the precoding codebook according to an embodiment of the present disclosure;

FIG. 8 is a timing diagram of a method for determining the precoding codebook according to an embodiment of the present disclosure;

FIG. 9 is a timing diagram of a method for determining the precoding codebook according to an embodiment of the present disclosure;

FIG. 10 is a timing diagram of a method for determining the precoding codebook according to an embodiment of the present disclosure;

FIG. 11 is a block diagram of a device for determining the precoding codebook according to an embodiment of the present disclosure;

FIG. 12 is a block diagram of a device for determining the precoding codebook according to an embodiment of the present disclosure;

FIG. 13 is a structural schematic diagram of a communication device according to an embodiment of the present disclosure;

FIG. 14 is a structural schematic diagram of a chip provided in an embodiment of the present disclosure.

### DETAILED DESCRIPTION OF THE INVENTION

The embodiments of the present disclosure are described in detail below, examples of which are illustrated in the accompanying drawings. Throughout the drawings, like or similar reference numerals indicate like or similar elements or elements having like or similar functions. The embodiments described below with reference to the accompanying drawings are examples and are intended to explain the present disclosure, and could not be understood as limiting the present disclosure.

In recent years, with the development of a smart terminal and its applications, the demand for multimedia services has grown rapidly. Consequently, to ensure a requirement of the quality of service (QoS) of a mobile application, the capacity of a wireless communication network must be increased. Meanwhile, telecom manufacturers and operators also have foreseen that the load of wireless communication network is growing exponentially. Consequently, it is necessary to introduce a new technology to meet the demand for explosive traffic in the next-generation wireless communication network. Bandwidth Efficiency (BE) is usually one of the most important indicators for selecting a candidate technology in the next-generation wireless communication system. Meanwhile, due to high power consumption of the wireless communication network, carbon emissions and expenditures of the operators have been increasing year by year. Consequently, energy efficiency (EE) has become another one important indicator for evaluating the performance of the wireless communication system under a given BE constraint condition. A multiple input multiple output (MIMO) technology can improve data throughput and link range without increasing bandwidth or transmission power, and thus has attracted a wide attention in the industry. In a case where a transmitting side uses a plurality of antennas, inter-user interference may be largely eliminated by using the asymptotic orthogonality between MIMO channels, and which can improve performance. Meanwhile, a large antenna array at a sending side also brings a capacity gain. Additional benefits of the MIMO include: improved BE without increasing base station (BS) density, enhanced EE by widely using inexpensive low-power components, enhanced ability to focus transmitted signal energy in a smaller area, and so on.

In a MIMO system, the performance of a codebook-based precoding technology is closely related to the design of a codebook. A discrete Fourier transform (DFT) codebook currently used may achieve good effects in a line of sight channel. However, in an actual communication scenario, in a case where there is an obstruction (such as an obstacle) on a line of sight (LOS) path, the signal transmission capability of the line of sight path is weakened. In such a scenario, the conventional DFT codebook may lead to poor performance of the MIMO system. Here, the line of sight path refers to the shortest and most direct propagation path between a transmitting antenna and a receiving antenna.

In view of this, the present disclosure proposes a method and device for determining a precoding codebook, which can solve the technical problem of poor performance of the MIMO system in a case where the line of sight path is weak.

FIG. 1 illustrates a schematic flowchart of a method for determining the precoding codebook according to an embodiment of the present disclosure. As shown in FIG. 1, the method is performed by a network device, where the network device may be a base station, a relay, a reconfigurable intelligent surface, and the like, and the embodiment may include the following steps.

Step 101: determine a first codebook for data transmission, where the first codebook is generated based on channel information of at least one terminal.

The channel is a wireless MIMO communication channel, which includes a plurality of non-line of sight channels in addition to a line of sight channel. The channel information may include channel quality indicator (CQI), channel state information (CSI) and other information, which is not specifically limited here. The at least one terminal is a terminal for multi-antenna joint transmission with the network device, where the terminal may be a cellphone, a laptop, a tablet computer, a multi-functional terminal (e.g. point of sale (POS)), a vehicle-mounted computer and other communication devices, which is not limited to the present disclosure. In a case where the line of sight path is weak, generating the codebook for the data transmission by using the channel information containing various channels can ensure the performance of the MIMO system.

According to the embodiment of the present disclosure, a new codebook generation method is provided, the network device or the terminal can generate a corresponding codebook by using such preset codebook generation method in combination with channel information.

The corresponding implementation steps of the preset codebook generation method may include:
1. obtain channel information of the at least one terminal, and construct a channel information set by using the channel information. For example, the channel information may be obtained by the network device via integrating the channel information uploaded by the at least one terminal, or the network device may obtain the channel information of the at least one terminal via channel estimation according to the channel reciprocity.
2. generate an initial codebook, which can be initially generated in the following manners:
   generate randomly; and
   obtain at an equal interval from a multi-dimensional vector space.
3. group the channel information set, which may be grouped according to a channel capacity maximization criterion or a received power maximization criterion, and allocate the channel information in the channel information set to a codeword in the codebook.
4. calculate an optimal precoding matrix corresponding to each channel information group according to a same rule, and synthesize the optimal precoding matrices for each channel information group to determine a new codeword, where the synthesization method may include:
   calculate a weighted average value, that is, sum each precoding matrix with weights, and calculate the average value.
5. repeat steps 3 and 4 until convergence, and output the codebook.

In a specific application scenario, in a case where the network device determines the first codebook, as a possible implementation, the terminal may determine the channel information based on channel estimation, generate a second codebook applicable for its own channel information by using the above preset codebook generation method, and report second codebook information of the second codebook to the network device. Correspondingly, the network device may receive the second codebook information reported by one or more terminals, and further determine, according to the second codebook information reported by the at least one terminal, the first codebook simultaneously applicable to the channel information of the at least one terminal, which enables the at least one terminal to perform data transmission with the network device by using the first codebook. For specific implementation details, reference may be made to related descriptions in steps 201 to 202 of the embodiments. As a possible implementation, the network device may integrate and determine the channel information of the at least one terminal, and further directly generate, based on the integrated channel information, the first codebook by using the preset codebook generation method described above, where the first codebook is suitable for data transmission of the at least one terminal within the network coverage. For specific implementation details, reference may be made to related descriptions in steps 301 to 303 or 401 to 403 of the embodiments.

Step 102: send first codebook information of the first codebook to the at least one terminal.

The first codebook information may include at least one of: all codewords in the first codebook; or information of a change in the codewords in the first codebook compared with codewords in the first codebook before updating. The information of the change in the codewords in the first codebook compared with the codewords in the first codebook before updating may include codeword changing information under operations such as adding a codeword, deleting a codeword and replacing a codeword.

According to the embodiment of the present disclosure, the purpose for the network device sending the first codebook information to the terminal is to enable the terminal to obtain the first codebook according to the first codebook information. As a possible implementation, in a case where the network device sends all the codewords in the first codebook to the terminal, and the terminal may determine the first codebook according to the index of the received codewords. As a possible implementation, in a case where the network device sends the information of the change in the codewords in the first codebook compared with the codewords in the first codebook before updating to the terminal, the terminal may determine the current first codebook sent by the network device according to the previous codebook sent by the network device and the information of the change.

Step 103: receive indication information of a precoding matrix sent by the terminal.

In a specific application scenario, after receiving the first codebook information sent by the network device, the terminal may determine the precoding matrix according to the first codebook information and the current channel information of the terminal, and further send the indication information of the precoding matrix to the network device, where the indication information of the precoding matrix includes index information of a codeword for the data transmission in the first codebook. Accordingly, after receiving the indication information of the precoding matrix, the network device may decode to obtain the precoding matrix according to the index information of the codeword for the data transmission.

Step 104: determine the precoding matrix for the data transmission according to the indication information of the precoding matrix, and send at least one of data or a reference signal to the terminal by using the precoding matrix.

According to the embodiment of the present disclosure, the network device can determine the precoding matrix for the data transmission with the corresponding terminal according to indication information, sent by the at least one terminal, of the precoding matrix, and send at least one of the data or the reference signal to the terminal by using the precoding matrix. The precoding matrices of the at least one terminal may be same or different, which may be adaptively determined according to the channel information corresponding to respective terminals.

In summary, according to the method for determining the precoding codebook provided in the embodiment of the present disclosure, the network device can generate the first codebook for the data transmission by using the channel information, where the channel information includes the channel information of the non-line of sight channel. In a case where the line of sight path is weak, generating the codebook with such the codebook generation method can ensure the performance of the MIMO system.

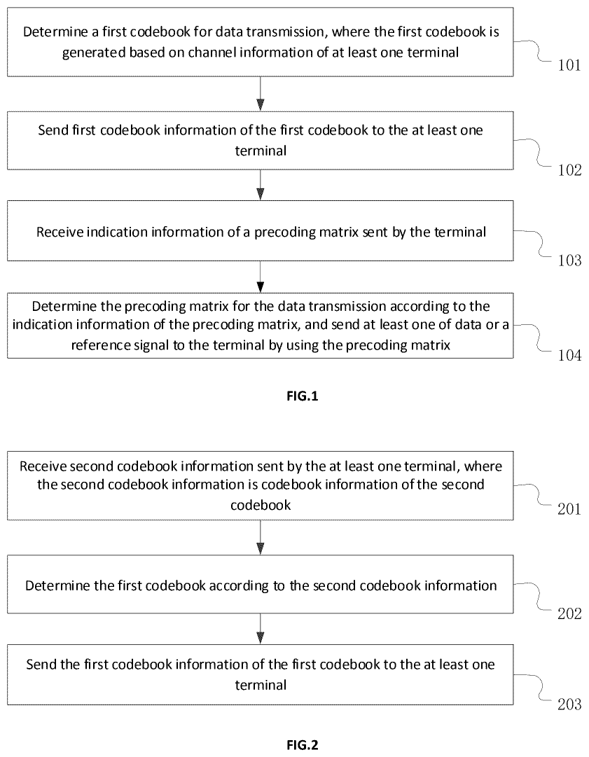

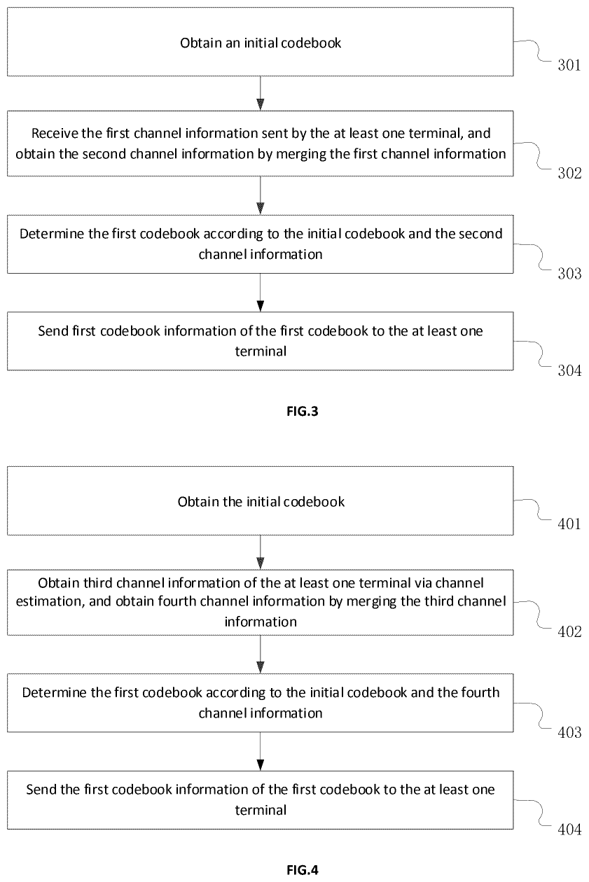

FIG. 2 illustrates a method for determining the precoding codebook according to an embodiment of the present disclosure, which is performed by the network device. Based on the embodiment shown in FIG. 1, and as shown in FIG. 2, the method may include the following steps.

Step 201: receive second codebook information sent by the at least one terminal, where the second codebook information is codebook information of the second codebook.

The second codebook information includes at least one of: all codewords in the second codebook; or information of a change in the codewords in the second codebook compared with codewords in the second codebook before updating. The information of the change in the codewords in the second codebook compared with codewords in the second codebook before updating may include codeword changing information under the operations such as adding the codeword, deleting the codeword and replacing the codeword.

In a specific application scenario, the terminal may generate the second codebook based on the channel information collected by itself and the codebook generation method shown in step 101 of the embodiments, and send the second codebook information of the second codebook to the network device, so that the network device can further determine the first codebook for the data transmission according to the received second codebook information.

According to the embodiment of the present disclosure, the purpose of the terminal reporting the second codebook information is to enable the network device to obtain the second codebook based on the second codebook information. As a possible implementation, in a case where the terminal sends all the codewords in the second codebook to the network device, the network device may determine the second codebook according to the index of the received codewords. As a possible implementation, in a case where the terminal sends the information of the change in the codewords in the second codebook compared with codewords in the second codebook before updating to the network device, the network device may determine the current second codebook reported by the terminal according to the previous codebook reported by the terminal and the information of the change.

Step 202: determine the first codebook according to the second codebook information.

In a specific application scenario, the network device may receive the second codebook information reported by one or more terminals. According to the embodiment of the present disclosure, as a possible implementation, after receiving the second codebook information sent by the terminal, the network device may first determine the second codebook sent by each terminal according to the second codebook information, select the codeword from at least one second codebook generated by the at least one terminal, and further determine the first codebook applicable for the data transmission to the at least one terminal within the network coverage according to the selected codeword. For example, after receiving a plurality of second codebooks sent by a plurality of terminals, in a case where the network device selects the codeword from the plurality of second codebooks to determine the first codebook, as a possible implementation, the network device may merge all the codewords in the second codebook, select the codeword from all the merged codewords randomly or according to a preset selection rule, and obtain the first codebook by combining the selected codeword. As a possible implementation, all the codewords in the second codebook may be merged, and the first codebook may be obtained by deduplicating all the merged codewords. It might be noted that if the network device selects the codeword from the plurality of second codebooks to determine the first codebook, other possible implementations may also be applicable, which are not specifically limited here.

Step 203: send the first codebook information of the first codebook to the at least one terminal.

In summary, according to the method for determining the precoding codebook provided in the embodiment of the present disclosure, the network device can receive the second codebook generated by the terminal using its own channel information, and further generate the first codebook for the data transmission according to the second codebook, where the channel information of the terminal includes the channel information of the non-line of sight channel. In a case where the line of sight path is weak, using such a codebook generation method can also ensure the performance of the MIMO system.

FIG. 3 illustrates a method for determining the precoding codebook according to an embodiment of the present disclosure, which is performed by the network device. Based on the embodiment shown in FIG. 1, and as shown in FIG. 3, the method may include the following steps.

Step 301: obtain an initial codebook.

The initial codebook may be generated randomly, or may be obtained at the equal interval from the multi-dimensional vector space.

Step 302: receive the first channel information sent by the at least one terminal, and obtain the second channel information by merging the first channel information.

Step 303: determine the first codebook according to the initial codebook and the second channel information.

According to the embodiment of the present disclosure, the first codebook may be obtained by iteratively updating each codeword in the initial codebook with the channel information set constructed from the second channel information. The process of iteratively updating may include: group the channel information set constructed from the second channel information based on a preset optimization criterion, and allocate the second channel information to the codeword in the codebook, that is, map a channel information group with a first codeword in the initial codebook, so that each first codeword in the initial codebook corresponds to one channel information group; further, obtain the optimal precoding matrix corresponding to each channel information group according to the same rule, determine the second codeword for each channel information group by synthesizing optimal precoding matrices corresponding to each channel information group, replace the mapped first codeword with the second codeword for each channel information group, and then regroup the channel information set based on the updated first codeword to update the first codeword again based on a new group; and repeat the above operation of updating the first codeword until any one of the first codewords in the codebook no longer changes, and determine the current codebook as the first codebook. Accordingly, the steps of the embodiment may include: group the second channel information based on the preset optimization criterion, where a number of channel information groups is equal to a number of codewords in the initial codebook; map the channel information group with the first codeword in the initial codebook; obtain the optimal precoding matrix corresponding to each channel information group according to the same rule; determine a codeword synthesized from the optimal precoding matrices for each channel information group as the second codeword for each channel information group; replace the mapped first codeword with the second codeword for each channel information group; and iteratively repeat the listed steps, until the first codeword corresponding to each channel information group no longer changes, and determine a codebook with the first codeword that no longer changes for each channel information group as the first codebook. The preset optimization criterion may include the channel capacity maximization criterion or the received power maximization criterion, which is not specifically limited here. Accordingly, in a case where the codeword synthesized from the optimal precoding matrices for each channel information group is determined as the second codeword for each channel information group. As a preferred implementation, the following steps may be included: calculate a weighted average value of the optimal precoding matrices for each channel information group, and determine the synthesized codeword as the second codeword for each channel information group.

For example, the method for generating the first codebook may include:
1. after obtaining L second channel information via merging, further construct the channel information set by using the L second channel information.

$$T = \{ {H}_{1} , {H}_{2} , … , {H}_{L} \}$$

2. obtain the initial codebook as B=[B₁, B₂, . . . , B_{q}, . . . , B_{Q}].
3. obtain the channel information group of the q-th initial codeword in the initial codebook by grouping the channel information set constructed from the L second channel information, based on the preset optimization criterion (taking the channel capacity maximization criterion as an example), where the q-th channel information group meets that:

$${x}_{{q}_{2}} = \{ {H}_{1} : {R}_{{B}_{q} , l} \geq {R}_{{B}_{q} , l} ∀ {q}^{′} = 1 , 2 , … , Q \} and$$

$${R}_{{B}_{q} , l} = {log}_{2} ( det \vert {I}_{{N}_{s}} + {H}_{l} {B}_{q , l} {B}_{q , l}^{H} {H}_{l}^{H} \vert ) .$$

Where x_{q}_{₂} is the channel capacity maximization criterion that the q-th channel information group needs to satisfy, R_{B}_{_{q}}_{,l} is the channel capacity, I_{N}_{ₛ} is the Ns*Ns identity matrix, B_{q,l} is the first codeword of the q-th channel information group of the initial codebook,

$${B}_{q , l}^{H}$$

is the conjugate transpose of B_{q,l}, Hₗ is the second channel information in the q-th channel information group, and

$${H}_{l}^{H}$$

is the conjugate transpose of Hₗ;
4. calculate a second codeword of the q-th channel information group:

$${max}_{{W}_{g , l}} {log}_{2} ( det \vert {I}_{{N}_{s}} + \frac{P}{{σ}_{n}^{2} {N}_{s}} {H}_{l} {W}_{q , l} {W}_{q , l}^{H} {H}_{l}^{H} \vert ) ,$$

which may be solved by a water filling power allocation algorithm, where P is the transmission power,

$${σ}_{n}^{2}$$

is the noise power, Nₛ is the number of data streams transmitted, W_{q,l} is the optimal precoding matrix corresponding to the l-th second channel information in the q-th channel information group, and

$${W}_{q , l}^{H}$$

is the conjugate transpose of W_{q,l}. The second channel information belongs to the q-th channel information group, a new second codeword B_{q} is obtained by calculating the center of W_{q,l} for all the channel information in the q-th channel information group, and the first codeword corresponding to the q-th channel information group is replaced with the second codeword. In this way, the first codeword for each channel information group in the entire codebook B is updated, where the center may be calculated by the following formula:

$$\frac{{\sum }_{i = 1}^{{L}_{q}} {W}_{q , l}}{{L}_{q}} ,$$

where L_{q} is the number of His in the q-th channel information group (i.e., the number of W_{q,l}s).
5. repeat steps 3 and 4, until no more change occurs, and output the first codebook.

Step 304: send first codebook information of the first codebook to the at least one terminal.

In summary, according to the method for determining the precoding codebook provided in the embodiment of the present disclosure, the network device can merge the first channel information sent by the at least one terminal, and generate the first codebook for user data transmission by using the merged second channel information, where the second channel information includes the channel information of the non-line of sight channel. In a case where the line of sight path is weak, generating a codebook with such a codebook generation method can ensure the performance of the MIMO system.

FIG. 4 illustrates a method for determining the precoding codebook according to an embodiment of the present disclosure, which is performed by the network device. Based on the embodiment shown in FIG. 1, and as shown in FIG. 4, the method may include the following steps.

Step 401: obtain the initial codebook.

The initial codebook may be generated randomly, or may be obtained at the equal interval from the multi-dimensional vector space.

Step 402: obtain third channel information of the at least one terminal via channel estimation, and obtain fourth channel information by merging the third channel information.

Step 403: determine the first codebook according to the initial codebook and the fourth channel information.

According to the embodiment of the present disclosure, the first codebook may be obtained by iteratively updating each codeword in the initial codebook with the channel information set constructed from the fourth channel information. The process of iteratively updating may include: group the channel information set constructed from the fourth channel information based on the preset optimization criterion, and allocate the fourth channel information to the codeword in the codebook, that is, map the channel information group with the first codeword in the initial codebook, so that each first codeword in the initial codebook corresponds to one channel information group; further, obtain the optimal precoding matrix corresponding to each channel information group according to the same rule, determine the second codeword for each channel information group by synthesizing the optimal precoding matrices corresponding to each channel information group, replace the mapped first codeword with the second codeword for each channel information group, and then regroup the channel information set based on the updated first codeword to update the first codeword again based on a new group; and repeat the above operation of updating the first codeword until any one of the first codewords in the codebook no longer changes, and determine the current codebook as the first codebook. For specific implementation process, reference may be made to related descriptions in step 303 of the embodiments, which will not be elaborated here.

In a specific application scenario, steps of the embodiment may include: group the fourth channel information based on the preset optimization criterion, where the number of channel information groups is equal to the number of codewords in the initial codebook; map the channel information group with the first codeword in the initial codebook; obtain the optimal precoding matrix corresponding to each channel information group according to the same rule; determine the codeword synthesized from the optimal precoding matrices for each channel information group as the second codeword for each channel information group; replace the mapped first codeword with the second codeword for each channel information group; and iteratively repeat the listed steps until the first codeword corresponding to each channel information group no longer changes, and determine the codebook with the first codeword that no longer changes for each channel information group as the first codebook. The preset optimization criterion may include the channel capacity maximization criterion or the received power maximization criterion, which is not specifically limited here. Accordingly, in a case where the codeword synthesized from the optimal precoding matrices for each channel information group is determined as the second codeword for each channel information group. As a preferred implementation, the following steps may be included: calculate the weighted average value of the optimal precoding matrices for each channel information group, and determine the synthesized codeword as the second codeword for each channel information group.

Step 404: send the first codebook information of the first codebook to the at least one terminal.

In summary, according to the method for determining the precoding codebook provided in the embodiment of the present disclosure, the network device can obtain the third channel information of the at least one terminal via channel estimation, merge the third channel information of the at least one terminal, and further generate the first codebook for user data transmission by using the merged fourth channel information, where the fourth channel information includes the channel information of the non-line of sight channel. In a case where the line of sight path is weak, generating the codebook with such the codebook generation method can ensure the performance of the MIMO system.

FIG. 5 is a schematic flowchart of a method for determining the precoding codebook according to an embodiment of the present disclosure. The method is performed by the terminal, and the embodiment may include the following steps.

Step 501: receive first codebook information sent by the network device, where the first codebook information is codebook information of the first codebook for the data transmission.

The first codebook is generated based on channel information of the at least one terminal, and a channel refers to the wireless MIMO communication channel. The channel includes the plurality of non-line of sight channels in addition to the line of sight channel. The channel information may include the channel quality indicator (CQI), the channel state information (CSI) and other information, which is not specifically limited here. The at least one terminal is the terminal for multi-antenna joint transmission with the network device, where the terminal may be the cellphone, the laptop, the tablet computer, the multi-functional terminal (e.g. point of sale (POS)), the vehicle-mounted computer, and other communication devices, which are not limited to the present disclosure. In a case where the line of sight path is weak, generating the codebook for the data transmission by using channel information containing various channels can ensure the performance of the MIMO system.

In a specific application scenario, as a possible implementation, the at least one terminal performing the multi-antenna joint transmission with the network device may determine channel information via channel estimation, generate the second codebook applicable for its own channel information by using the preset codebook generation method, and report second codebook information of the second codebook to the network device. Accordingly, the network device may determine a first codebook applicable for the channel information of the at least one terminal according to the second codebook information reported by the at least one terminal. As a possible implementation, the at least one terminal may upload, after obtaining its own channel information, the channel information to the network device, so that the network device integrates and determines the channel information of the at least one terminal, and further directly generate, based on the integrated channel information, a first codebook applicable for the data transmission to the at least one terminal within network coverage by using the preset codebook generation method. According to the embodiment of the present disclosure, after determining the first codebook, the network device may send the first codebook information of the first codebook to the terminal, so that the terminal can obtain the first codebook according to the first codebook information, and determine the precoding matrix according to the first codebook. The codebook information of the first codebook includes at least one of: all codewords in the first codebook; or information of a change in the codewords in the first codebook compared with codewords in the first codebook before updating. The information of the change in the codewords in the first codebook compared with the codewords in the first codebook before updating may include codeword changing information under the operations such as adding the codeword, deleting the codeword and replacing the codeword.

Step 502: determine the precoding matrix for the data transmission according to the first codebook information and the first channel information.

According to the embodiment of the present disclosure, after receiving the first codebook information sent by the network device, the terminal may first determine the first codebook according to the first codebook information, and further determine a precoding matrix that matches the first channel information of the terminal itself from the first codebook. In a case where the precoding matrix that matches the channel information is determined from the first codebook, a third codeword for the data transmission that matches the first channel information may be selected from the first codebook, and a precoding matrix corresponding to the third codeword may be determined as the precoding matrix for the data transmission. Specifically, the third codeword may be selected based on the preset criterion, where the preset criterion may be the channel capacity maximization criterion, the received power maximization criterion, or an interference minimization criterion. Accordingly, in a case where the terminal determines the first codebook according to the first codebook information, as a possible implementation, the network device sends all the codewords in the first codebook to the terminal, and the terminal may determine the first codebook according to the codeword index of all the codewords received. As a possible implementation, in a case where the network device sends the information of the change in the codewords in the first codebook compared with the codewords in the first codebook before updating to the terminal, the terminal may determine the current first codebook sent by the network device according to the previous codebook sent by the network device and the information of the change.

Step 503: send indication information of the precoding matrix to the network device.

The indication information of the precoding matrix may include index information of the third codeword for the data transmission in the first codebook. Accordingly, according to the embodiment of the present disclosure, after determining the precoding matrix, the terminal may further extract the index information of each third codeword in the precoding matrix, and then send the index information of each third codeword in the precoding matrix as the indication information of the precoding matrix to the network device, so that the network device can determine the precoding matrix based on the index of each third codeword in the precoding matrix.

In summary, according to the method for determining the precoding codebook provided in the embodiment of the present disclosure, the terminal can receive the first codebook information, sent by the network device, of the first codebook for the data transmission, where the first codebook is generated by using the channel information, and the channel information includes channel information of the non-line of sight channel. In a case where the line of sight path is weak, generating the codebook with such a codebook generation method can ensure the performance of the MIMO system.

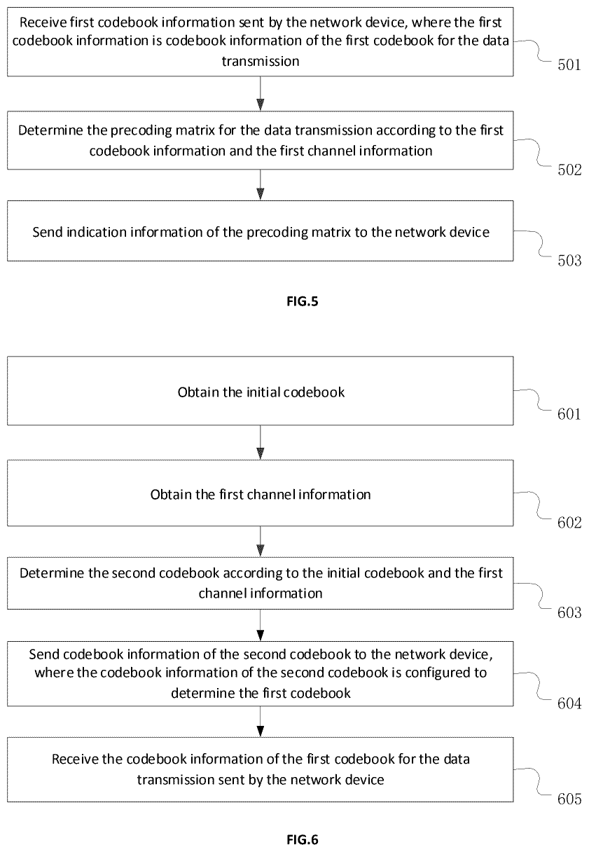

FIG. 6 illustrates a method for determining the precoding codebook according to an embodiment of the present disclosure, which is performed by the terminal. Based on the embodiment shown in FIG. 5, and as shown in FIG. 6, the method may include the following steps.

Step 601: obtain the initial codebook.

Step 602: obtain the first channel information.

In a specific application scenario, the terminal may collect the first channel information via channel estimation. The first channel information may include channel information of the plurality of non-line of sight channels in addition to the channel information of the line of sight channel. In a case where the line of sight path is weak, generating the codebook using the first channel information containing various channel information can ensure the performance of the MIMO system.

Step 603: determine the second codebook according to the initial codebook and the first channel information.

According to the embodiment of the present disclosure, a new codebook generation method is provided, where the terminal can generate the second codebook by using such a codebook generation method in combination with the channel information.

The corresponding implementation steps of the new codebook generation method may include:
1. obtain first channel information, and construct the channel information set by using the first channel information.
2. generate the initial codebook, which can be initially generated in the following manners:
   generate randomly; and
   obtain at the equal interval from the multi-dimensional vector space.
3. group the channel information set, which can be grouped according to the channel capacity maximization criterion or the received power maximization criterion, and allocate the channel information in the channel information set to the codeword in the codebook.
4. calculate the optimal precoding matrix corresponding to each channel information group according to the same rule, and synthesize the optimal precoding matrices for each channel information group as the new codeword, where the synthesization method may include:
   calculate the weighted average value, that is, sum up each precoding matrix with weights, and calculate the average value.
5. repeat steps 3 and 4 until convergence, and output the codebook.

Correspondingly, according to the embodiment of the present disclosure, the steps of the embodiment may include: group the first channel information based on the preset optimization criterion, where the number of channel information groups is equal to the number of codewords in the initial codebook; map the channel information group with the first codeword in the initial codebook; obtain the optimal precoding matrix corresponding to each channel information group according to the same rule; determine the codeword synthesized from the optimal precoding matrices for each channel information group as the second codeword for each channel information group; replace the mapped first codeword with the second codeword for each channel information group; and iteratively repeat the listed steps, until the first codeword corresponding to each channel information group no longer changes, and determine the codebook with the first codeword that no longer changes for each channel information group as the second codebook. The preset optimization criterion may include the channel capacity maximization criterion or the received power maximization criterion, which is not specifically limited here. Accordingly, in a case where the codeword synthesized from the optimal precoding matrices for each channel information group is determined as the second codeword for each channel information group, as a preferred implementation, the following steps may be included: calculate the weighted average value of the optimal precoding matrices for each channel information group, and determine the synthesized codeword as the second codeword for each channel information group.

For example, the method for generating the second codebook may include:
1. after obtaining L first channel information via merging, further construct the channel information set by using the L first channel information.

$$T = \{ {H}_{1} , {H}_{2} , … , {H}_{L} \}$$

2. obtain the initial codebook as B=[B₁, B₂, . . . , B_{q}, . . . , B_{Q}].
3. obtain the channel information group of the q-th initial codeword in the initial codebook by grouping the channel information set constructed from the L first channel information groups, based on the preset optimization criterion (taking the criterion of channel capacity maximization criterion as an example), where the q-th channel information group meets that:

$${x}_{{q}_{2}} = \{ {H}_{1} : {R}_{{B}_{q} , l} \geq {R}_{{B}_{q} , l} ∀ {q}^{′} = 1 , 2 , … , Q \} and$$

$${R}_{{B}_{q} , l} = {log}_{2} ( det \vert {I}_{{N}_{s}} + {H}_{l} {B}_{q , l} {B}_{q , l}^{H} {H}_{l}^{H} \vert ) .$$

Where x_{q}_{₂} is the channel capacity maximization criterion that the q-th channel information group needed to satisfy, R_{B}_{_{q}}_{,l} is the channel capacity, I_{N}_{ₛ} is the Ns*Ns identity matrix, B_{q,l} is the first codeword of the q-th channel information group of the initial codebook,

$${B}_{q , l}^{H}$$

is the conjugate transpose of B_{q,l}, Hₗ is the first channel information in the q-th channel information group, and

$${H}_{l}^{H}$$

is the conjugate transpose of Hₗ;
4. calculate the second codeword of the q-th channel information group:

$${max}_{{W}_{q , l}} {log}_{2} ( det \vert {I}_{{N}_{s}} + \frac{P}{{σ}_{n}^{2} {N}_{s}} {H}_{l} {W}_{q , l} {W}_{q , l}^{H} {H}_{l}^{H} \vert ) ,$$

which may be solved by the water filling power allocation algorithm, where P is the transmission power,

$${σ}_{n}^{2}$$

is the noise power, Nₛ is the number of data streams transmitted, W_{q,l} is the optimal precoding matrix corresponding to the l-th first channel information in the q-th channel information group, and

$${W}_{q , l}^{H}$$

is the conjugate transpose of W_{q,l}. The first channel information belongs to the q-th channel information group, the new second codeword B_{q} is obtained by calculating the center of W_{q,l} for all the channel information in the q-th channel information group, and the first codeword corresponding to the q-th channel information group is replaced with the second codeword. In this way, the first codeword for each channel information group in the entire codebook B is updated, where the center may be calculated by the following formula:

$$\frac{{\sum }_{i = 1}^{{L}_{q}} {W}_{q , l}}{{L}_{q}} ,$$

where L_{q} is the number of His in the q-th channel information group (i.e., the number of W_{q,l}s).
5. repeat steps 3 and 4, until no more change occurs, and output the second codebook.

Step 604: send codebook information of the second codebook to the network device, where the codebook information of the second codebook is configured to determine the first codebook.

The codebook information of the second codebook includes at least one of: all codewords in the second codebook; or the information of the change in the codewords in the second codebook compared with the codewords in the second codebook before updating. The information of the change in the codewords in the second codebook compared with the codewords in the second codebook before updating may include the codeword changing information under the operations such as adding the codeword, deleting the codeword and replacing the codeword.

According to the embodiment of the present disclosure, the purpose of the terminal reporting the codebook information of the second codebook is to enable the network device to obtain the second codebook based on the codebook information of the second codebook, and further to determine the first codebook for the data transmission according to the codebook information of the second codebook. As a possible implementation, in a case where the terminal sends all the codewords in the second codebook to the network device, the network device may determine the second codebook according to the index of the received codewords. As a possible implementation, in a case where the terminal sends the information of the change in the codewords in the second codebook compared with codewords in the second codebook before updating to the network device, the network device may determine the current second codebook reported by the terminal according to the previous codebook reported by the terminal and the information of the change.

Step 605: receive the codebook information of the first codebook for the data transmission sent by the network device.

In summary, according to the method for determining the precoding codebook provided in the embodiment of the present disclosure, the terminal can generate the second codebook by using the second channel information, and send the second codebook information of the second codebook to the network device, so that the network device generates the first codebook for the data transmission according to the second codebook, where the second channel information includes the channel information of the non-line of sight channel. In a case where the line of sight path is weak, using such codebook generation method can ensure the performance of the MIMO system.

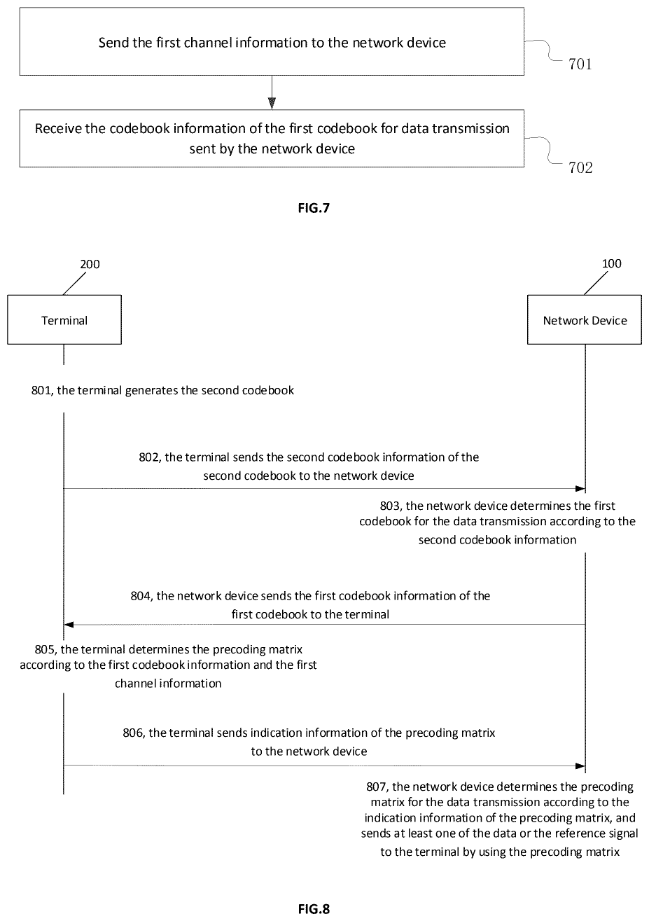

FIG. 7 illustrates a method for determining the precoding codebook according to an embodiment of the present disclosure, which is performed by the terminal. Based on the embodiment shown in FIG. 5, and as shown in FIG. 7, the method may include the following steps.

Step 701: send the first channel information to the network device.

In a specific application scenario, the terminal may collect the first channel information via channel estimation. The first channel information may include channel information of the plurality of non-line of sight channels in addition to channel information of the line of sight channel. After collecting the first channel information, the terminal uploads the first channel information to the network device, so that the network device obtains the second channel information by merging the first channel information uploaded by the at least one terminal, and determines the first codebook for the data transmission according to the second channel information, where the second channel information may include channel information of the plurality of non-line of sight channels corresponding to the at least one terminal, In a case where the line of sight path is weak, generating the codebook by using the second channel information containing various channel information corresponding to the at least one terminal can ensure the performance of the MIMO system.

Step 702: receive the codebook information of the first codebook for the data transmission sent by the network device.

In summary, according to the method for determining the precoding codebook provided in the embodiment of the present disclosure, the terminal sends the first channel information collected by itself to the network device, so that the network device can merge the first channel information sent by the at least one terminal, and to generate the first codebook for user data transmission by using the merged second channel information, where the second channel information includes the channel information of the non-line of sight channel. In a case where the line of sight path is weak, generating the codebook with such the codebook generation method can ensure the performance of the MIMO system.

FIG. 8 is a timing diagram of a method for determining the precoding codebook according to an embodiment of the present disclosure. The method is applied to a communication system for determining the precoding codebook. The system includes the network device 100 and the terminal 200, where the terminal generates the second codebook; the terminal sends the second codebook information of the second codebook to the network device; the network device determines the first codebook for the data transmission according to the second codebook information; the network device sends the first codebook information of the first codebook to the terminal; the terminal determines the precoding matrix according to the first codebook information and the first channel information; the terminal sends the indication information of the precoding matrix to the network device; and the network device determines the precoding matrix for the data transmission according to the indication information of the precoding matrix, and sends at least one of the data or the reference signal to the terminal by using the precoding matrix.

Referring to FIG. 8, the method includes the following steps.

Step 801: the terminal generates the second codebook.

In a specific application scenario, the terminal may collect first channel information via channel estimation, and determine the second codebook according to the first channel information. For specific implementation process, reference may be made to related descriptions in steps 601 to 603 of the embodiments, which will not be elaborated here.

Step 802: the terminal sends the second codebook information of the second codebook to the network device.

The second codebook information includes at least one of: all codewords in the second codebook; or the information of the change in the codewords in the second codebook compared with codewords in the second codebook before updating. The information of the change in the codewords in the second codebook compared with codewords in the second codebook before updating may include the codeword changing information under the operations such as adding the codeword, deleting the codeword and replacing the codeword.

According to the embodiment of the present disclosure, the purpose of the terminal reporting the codebook information of the second codebook is to enable the network device to obtain the second codebook according to the codebook information of the second codebook, and further to determine the first codebook for the data transmission according to the codebook information of the second codebook. As a possible implementation, in a case where the terminal sends all the codewords in the second codebook to the network device, the network device may determine the second codebook according to the index of the received codewords. As a possible implementation, when the terminal sends the information of the change in the codewords in the second codebook compared with the codewords in the second codebook before updating to the network device, the network device may determine the current second codebook reported by the terminal according to the previous codebook reported by the terminal and the information of the change.

Step 803: the network device determines the first codebook for the data transmission according to the second codebook information.

In a specific application scenario, the network device may receive the second codebook information reported by one or more terminals. According to the embodiment of the present disclosure, as a possible implementation, in a case where the network device receives the second codebook information reported by the terminal, the network device may first determine the second codebook sent by each terminal according to the second codebook information, further select the codeword from the at least one second codebook generated by the at least one terminal, and then determine the first codebook applicable for the data transmission to the at least one terminal under network coverage according to the selected codeword. For example, after receiving the plurality of second codebooks sent by the plurality of terminals, the network device selects the codeword from the plurality of second codebooks. In a case where the first codebook is determined, as a possible implementation, all the codewords in the second codebook are merged, the codeword is selected from all the merged codewords randomly or according to a preset selection rule, and the first codebook is obtained by combining the selected codeword. As a possible implementation, the network device may merge all the codewords in the second codebook, and obtain the first codebook by deduplicating all the merged codewords. It might be noted that in a case where the network device selects the codeword from the plurality of second codebooks and determines the first codebook, other possible implementations may also be applicable, which are not specifically limited here.

Step 804: the network device sends the first codebook information of the first codebook to the terminal.

Step 805: the terminal determines the precoding matrix according to the first codebook information and the first channel information.

In a specific application scenario, after receiving the first codebook information sent by the network device, the terminal may first determine the first codebook according to the first codebook information, and further determine the precoding matrix that matches the first channel information of the terminal itself from the first codebook. In a case where the precoding matrix that matches the channel information is determined from the first codebook, a third codeword for the data transmission that matches the first channel information may be selected from the first codebook, and the precoding matrix corresponding to the third codeword may be determined as the precoding matrix for the data transmission. Specifically, the third codeword may be selected based on the preset criterion, where the preset criterion may be the channel capacity maximization criterion, the received power maximization criterion, or the interference minimization criterion. Accordingly, in a case where the terminal determines the first codebook according to the first codebook information, as a possible implementation, the network device sends all the codewords in the first codebook to the terminal, and the terminal may determine the first codebook according to the codeword index of all the codewords received. As a possible implementation, in a case where the network device sends the information of the change in the codewords in the first codebook compared with the codewords in the first codebook before updating to the terminal, the terminal may determine the current first codebook sent by the network device according to the previous codebook sent by the network device and the information of the change.

Step 806: the terminal sends the indication information of the precoding matrix to the network device.

The indication information of the precoding matrix may include index information of the third codeword for the data transmission in the first codebook. Accordingly, for the embodiment of the present disclosure, after determining the precoding matrix, the terminal may further extract the index information of each third codeword in the precoding matrix, and then send the index information of each third codeword in the precoding matrix as the indication information of the precoding matrix to the network device, so that the network device can determine the precoding matrix based on the index of each third codeword in the precoding matrix.

Step 807: the network device determines the precoding matrix for the data transmission according to the indication information of the precoding matrix, and sends at least one of the data or the reference signal to the terminal by using the precoding matrix.

According to the embodiment of the present disclosure, the network device can determine the precoding matrix for the data transmission with the corresponding terminal according to indication information, sent by the at least one terminal, of the precoding matrix, and send at least one of the data or the reference signal to the terminal by using the precoding matrix. The precoding matrices of the at least one terminal may be same or different, which may be adaptively determined according to the channel information corresponding to respective terminals.

In summary, according to the method for determining the precoding codebook provided in the embodiment of the present disclosure, the terminal can generate the second codebook by using second channel information, and send the second codebook information of the second codebook to the network device, so that the network device generates the first codebook for the data transmission according to the second codebook, where the second channel information includes channel information of the non-line of sight channel. In a case where the line of sight path is weak, using such codebook generation method can ensure the performance of the MIMO system.

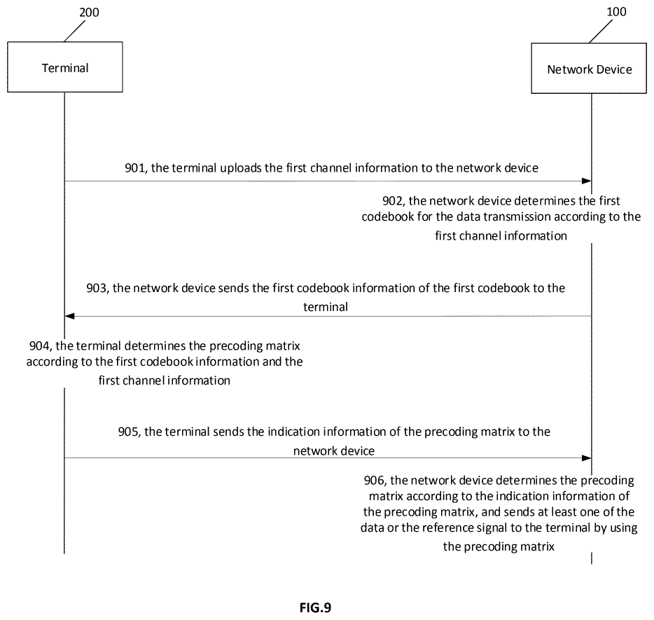

FIG. 9 is a timing diagram of a method for determining the precoding codebook according to an embodiment of the present disclosure. The method is applied to the communication system for determining the precoding codebook. The system includes the network device 100 and the terminal 200, where the terminal uploads the first channel information to the network device; the network device determines the first codebook for the data transmission according to the first channel information; the network device sends the first codebook information of the first codebook to the terminal; the terminal determines the precoding matrix for the data transmission according to the first codebook information and the first channel information; the terminal sends indication information of the precoding matrix to the network device; and the network device determines the precoding matrix according to the indication information of the precoding matrix, and sends at least one of the data or the reference signal to the terminal by using the precoding matrix.

Referring to FIG. 9, the method includes the following steps.

Step 901: the terminal uploads the first channel information to the network device.

In a specific application scenario, after collecting the first channel information, the terminal may upload the first channel information to the network device, so that the network device can obtain the second channel information by merging the first channel information uploaded by at least one terminal, and determine the first codebook for the data transmission according to the second channel information, where the second channel information may include the channel information of the plurality of non-line of sight channels in addition to the channel information of the line of sight channel. In a case where the line of sight path is weak, generating the codebook using the second channel information containing various channel information corresponding to the at least one terminal can ensure the performance of the MIMO system.

Step 902: the network device determines the first codebook for the data transmission according to the first channel information.

According to the embodiment of the present disclosure, the network device may obtain the second channel information by merging the first channel information uploaded by the at least one terminal, and determine the first codebook for the data transmission according to the second channel information. For specific implementation process, reference may be made to related descriptions in steps 301 to 303 of the embodiments, which will not be elaborated here.

Step 903: the network device sends the first codebook information of the first codebook to the terminal.

The first codebook information may include at least one of: all codewords in the first codebook; or the information of the change in the codewords of the first codebook compared with the codewords in the first codebook before updating. The information of the change in the codewords of the first codebook compared with the codewords in the first codebook before updating may include the codeword changing information under the operations such as adding the codeword, deleting the codeword and replacing the codeword.

Step 904: the terminal determines the precoding matrix according to the first codebook information and the first channel information.

According to the embodiment of the present disclosure, reference may be made to related descriptions in step 805 of the embodiments, which will not be elaborated here.

Step 905: the terminal sends the indication information of the precoding matrix to the network device.

According to the embodiment of the present disclosure, reference may be made to related descriptions in step 806 of the embodiments, which will not be elaborated here.

Step 906: the network device determines the precoding matrix according to the indication information of the precoding matrix, and sends at least one of the data or the reference signal to the terminal by using the precoding matrix.

According to the embodiment of the present disclosure, reference may be made to related descriptions in step 807 of the embodiments, which will not be elaborated here.

Through applying the method for determining the precoding codebook provided in the present embodiment, the network device can merge the first channel information sent by at least one terminal, and generate the first codebook for user data transmission by using the merged second channel information, where the second channel information includes channel information of the non-line of sight channel. In a case where the line of sight path is weak, generating the codebook with such the codebook generation method can ensure the performance of the MIMO system.

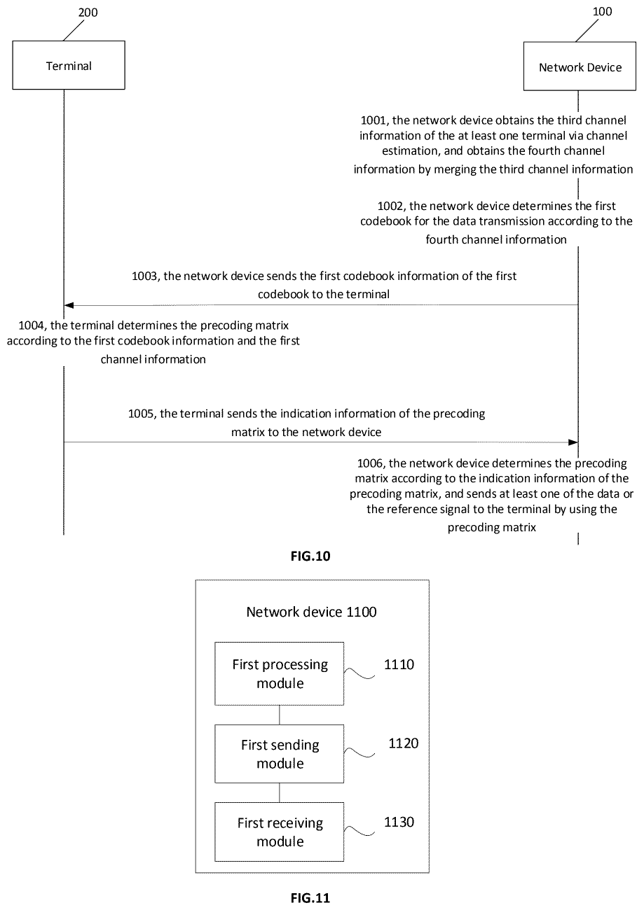

FIG. 10 is a timing diagram of a method for determining the precoding codebook according to an embodiment of the present disclosure. The method is applied to the communication system for determining the precoding codebook. The system includes the network device 100 and the terminal 200, where the network device obtains the third channel information of the at least one terminal via channel estimation, and obtains the fourth channel information by merging the third channel information; the network device determines the first codebook for the data transmission according to the fourth channel information; the network device sends the first codebook information of the first codebook to the terminal; the terminal determines the precoding matrix for the data transmission according to the first codebook information and the first channel information; the terminal sends the indication information of the precoding matrix to the network device; and the network device determines the precoding matrix according to the indication information of the precoding matrix, and sends at least one of the data or the reference signal to the terminal by using the precoding matrix.

Referring to FIG. 10, the method includes the following steps.

Step 1001: the network device obtains the third channel information of the at least one terminal via channel estimation, and obtains the fourth channel information by merging the third channel information.

Step 1002: the network device determines the first codebook for the data transmission according to the fourth channel information.

According to the embodiment of the present disclosure, for the specific implementation process, reference may be made to related descriptions in steps 401 to 403 of the embodiments, which will not be elaborated here.

Step 1003: the network device sends the first codebook information of the first codebook to the terminal.

The first codebook information may include at least one of: all codewords in the first codebook; and the information of the change in the codewords in the first codebook compared with the codewords in the first codebook before updating. The information of the change in the codewords in the first codebook compared with the codewords in the first codebook before updating may include the codeword changing information under the operations such as adding the codeword, deleting the codeword and replacing the codeword.

Step 1004: the terminal determines the precoding matrix according to the first codebook information and the first channel information.

According to the embodiment of the present disclosure, reference made be made to related descriptions in step 805 of the embodiments, which will not be elaborated here.

Step 1005: the terminal sends the indication information of the precoding matrix to the network device.

According to the embodiment of the present disclosure, reference may be made to related descriptions in step 806 of the embodiments, which will not be elaborated here.

Step 1006: the network device determines the precoding matrix according to the indication information of the precoding matrix, and sends at least one of the data or the reference signal to the terminal by using the precoding matrix.

According to the embodiment of the present disclosure, reference may be made to related descriptions in step 807 of the embodiments, which will not be elaborated here.

Through applying the method for determining the precoding codebook provided in the present embodiment, after obtaining the third channel information of the at least one terminal based on the channel estimation, the network device may merge the third channel information of the at least one terminal, and further generate the first codebook for user data transmission by using the merged fourth channel information, where the fourth channel information includes the channel information of the non-line of sight channel. In a case where the line of sight path is weak, generating the codebook with such the codebook generation method can ensure the performance of the MIMO system.

In the above embodiments provided in the present application, the methods provided in the embodiments of the present application are described from the perspectives of the network device and the terminal respectively. In order to implement various functions in the above methods provided in the embodiments of the present application, the network device and the terminal may include hardware structure and software module, and implement the above various functions in the form of the hardware structure, the software module, or a combination of the hardware structure and the software module. A certain one of the above various functions may be implemented in the form of the hardware structure, the software module, or the combination of the hardware structure and the software module.

Corresponding to the method for determining the precoding codebook provided in the above several embodiments, the present disclosure further provides a device for determining the precoding codebook. Since the device for determining the precoding codebook provided in the embodiments of the present disclosure corresponds to the method for determining the precoding codebook provided in the above embodiments, the implementation of the method for determining the precoding codebook is also applicable to the device for determining the precoding codebook provided in the present embodiment, which will not be redundantly elaborated in the present embodiment.

FIG. 11 is a structural schematic diagram of a device for determining the precoding codebook, which may be the network device 1100, according to an embodiment of the present disclosure.

As shown in FIG. 11, the network device 1100 may include:
a first processing module 1110, configured to determine a first codebook for data transmission, where the first codebook is generated based on channel information of at least one terminal; and
a first sending module 1120, configured to send first codebook information of the first codebook to the at least one terminal.

In some embodiments of the present disclosure, the first processing module 1110 may be configured to: receive second codebook information sent by the at least one terminal, where the second codebook information is codebook information of a second codebook; and determine the first codebook according to the second codebook information.

In some embodiments of the present disclosure, the second codebook information includes at least one of: all codewords in the second codebook; and information of change in the codewords of the second codebook compared with codewords in the second codebook before updating.

In some embodiments of the present disclosure, the first processing module 1110 may be configured to: merge all the codewords in the second codebook; and obtain the first codebook by deduplicating all the merged codewords.

In some embodiments of the present disclosure, the first processing module 1110 may be configured to: obtain an initial codebook; receive first channel information sent by the at least one terminal; obtain second channel information by merging the first channel information; and determine the first codebook according to the initial codebook and the second channel information.

In some embodiments of the present disclosure, the first processing module 1110 may be configured to: group the second channel information based on a preset optimization criterion, where the number of channel information groups is equal to the number of codewords in the initial codebook; map the channel information group with the first codeword in the initial codebook; obtain an optimal precoding matrix corresponding to each channel information group according to the same rule; determine a codeword synthesized from the optimal precoding matrices for each channel information group as a second codeword for each channel information group; replace the mapped first codeword with the second codeword for each channel information group; and iteratively repeat the listed steps, until the first codeword corresponding to each channel information group no longer changes, and determine a codebook with the first codeword that no longer changes for each channel information group as the first codebook.

In some embodiments of the present disclosure, the first processing module 1110 may be configured to: obtain an initial codebook; obtain third channel information of the at least one terminal via channel estimation; obtain fourth channel information by merging the third channel information; and determine the first codebook according to the initial codebook and the fourth channel information.

In some embodiments of the present disclosure, the first processing module 1110 may be configured to: group the fourth channel information based on a preset optimization criterion, where the number of channel information groups is equal to the number of codewords in the initial codebook; map the channel information group with the first codeword in the initial codebook; obtain an optimal precoding matrix corresponding to each channel information group according to the same rule; determine a codeword synthesized from the optimal precoding matrices for each channel information group as a second codeword for each channel information group; replace the mapped first codeword with the second codeword for each channel information group; and iteratively repeat the listed steps, until the first codeword corresponding to each channel information group no longer changes, and determine a codebook with the first codeword that no longer changes for each channel information group as the first codebook.

In some embodiments of the present disclosure, the first processing module 1110 may be configured to: generate the initial codebook randomly; and obtain the initial codebook at an equal interval from a multi-dimensional vector space.

In some embodiments of the present disclosure, the first processing module 1110 may be configured to: calculate a weighted average value of the optimal precoding matrices for each channel information group, and determine the synthesized codeword as the second codeword for each channel information group.

In some embodiments of the present disclosure, the first codebook information includes at least one of: all codewords in the first codebook; or information of a change in the codewords in the first codebook compared with codewords in the first codebook before updating.

In some embodiments of the present disclosure, as shown in FIG. 11, the network device 1100 further includes a first receiving module 1130.

The first receiving module 1130 may be configured to receive indication information of a precoding matrix sent by the terminal.

In some embodiments of the present disclosure, the first processing module 1110 may be configured to: determine a precoding matrix for the data transmission according to the indication information of the precoding matrix; and send at least one of data or a reference signal to the terminal by using the precoding matrix.

In some embodiments of the present disclosure, the indication information includes index information of a third codeword for the data transmission in the first codebook.

In some embodiments of the present disclosure, the first processing module 1110 may be configured to: determine a precoding matrix corresponding to the index information in the first codebook as the precoding matrix for transmitting data.

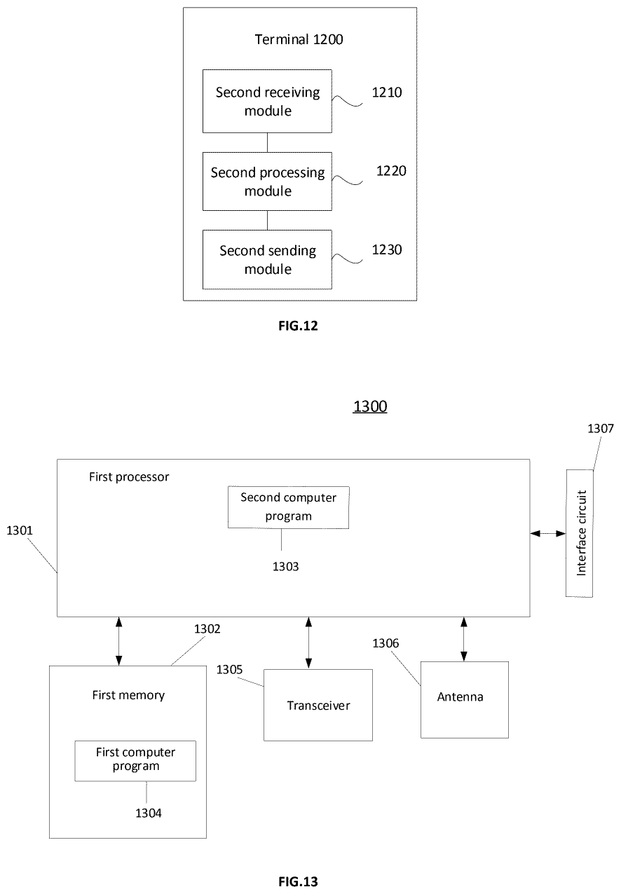

FIG. 12 is a structural schematic diagram of a terminal 1200 provided in an embodiment of the present disclosure.

As shown in FIG. 12, the terminal 1200 may include:
a second receiving module 1210, configured to: receive first codebook information sent by a network device, where the first codebook information is codebook information of a first codebook for data transmission, and the first codebook is generated based on channel information of at least one terminal.

In some embodiments of the present disclosure, the first codebook information includes at least one of: all codewords in the first codebook; and information of a change in the codewords of the first codebook compared with codewords in the first codebook before updating.

In some embodiments of the present disclosure, as shown in FIG. 12, the terminal 1200 further includes a second processing module 1220.

The second processing module 1220 may be configured to: obtain an initial codebook; obtain first channel information; and determine a second codebook according to the initial codebook and the first channel information.

In some embodiments of the present disclosure, the second processing module 1220 may be configured to: generate the initial codebook randomly; and obtain the initial codebook at an equal interval from a multi-dimensional vector space.

In some embodiments of the present disclosure, the second processing module 1220 may be configured to obtain the first channel information via channel estimation.

In some embodiments of the present disclosure, the second processing module 1220 may be configured to: group the first channel information based on a preset optimization criterion, where the number of channel information groups is equal to the number of codewords in the initial codebook; map the channel information group with the first codeword in the initial codebook; obtain an optimal precoding matrix corresponding to each channel information group according to the same rule; determine a codeword synthesized from the optimal precoding matrices for each channel information group as a second codeword for each channel information group; replace the mapped first codeword with the second codeword for each channel information group; and iteratively repeat the listed steps, until the first codeword corresponding to each channel information group no longer changes, and determine a codebook with the first codeword that no longer changes for each channel information group as the second codebook.

In some embodiments of the present disclosure, the second processing module 1220 may be configured to: calculate a weighted average value of the optimal precoding matrices for each channel information group, and determine the synthesized codeword as the second codeword for each channel information group.

In some embodiments of the present disclosure, as shown in FIG. 12, the terminal 1200 further includes a second sending module 1230.

The second sending module 1230 may be configured to send second codebook information to the network device, where the second codebook information is codebook information of the second codebook.

In some embodiments of the present disclosure, the second codebook information includes at least one of: all codewords in the second codebook; and information of a change in the codewords in the second codebook compared with codewords in the second codebook before updating.

In some embodiments of the present disclosure, the second sending module 1230 may be configured to: send first channel information to the network device.

In some embodiments of the present disclosure, the second processing module 1220 may be configured to: determine a precoding matrix for the data transmission according to the first codebook information and the first channel information; and the second sending module 1230 may be configured to: send indication information of the precoding matrix to the network device.

In some embodiments of the present disclosure, the second processing module 1220 may be configured to: select a third codeword for the data transmission that matches the first channel information from the first codebook; and determine a precoding matrix corresponding to the third codeword as the precoding matrix for the data transmission.

In some embodiments of the present disclosure, the indication information includes index information of the third codeword for the data transmission in the first codebook.

Referring to FIG. 13, FIG. 13 is a structural schematic diagram of a communication device 1300 provided in an embodiment of the present application. The communication device 1300 may be a network device or a user equipment, or may be a chip, a chip system or a processor that supports the network device to implement the above method, or may be a chip, a chip system or a processor that supports the user equipment to implement the above method. The device can be configured to implement the method described in the above method embodiments, and for details, reference may be made to the illustration in the above method embodiments.

The communication device 1300 may include one or more first processors 1301. The first processor 1301 may be a general processor or a dedicated processor. For example, the first processor 1301 may be a baseband processor or a central processing unit. The baseband processor may be configured to process a communication protocol and communication data, and the central processing unit may be configured to control the communication device (such as a base station, a baseband chip, a terminal, a terminal chip, a distributed unit (DU) or a centralized unit (CU)), implement a computer program, and process data of the computer program.

Optionally, the communication device 1300 may further include one or more first memories 1302, in which a first computer program 1304 may be stored. The first processor 1301 implements the first computer program 1304, so that the communication device 1300 can perform the method described in the above method embodiments. Optionally, the first memory 1302 may also store data. The communication device 1300 and the first memory 1302 may be disposed separately, or integrated together.

Optionally, the communication device 1300 may further include a transceiver 1305 and an antenna 1306. The transceiver 1305 may be referred to as a transceiver unit, a transceiver, a transceiver circuit, etc., and is configured to implement the transceiving function. The transceiver 1305 may include a receiver and a transmitter. The receiver may be referred to as a receiver or a receiving circuit, etc., and is configured to implement the receiving function. The transmitter may be referred to as a transmitter or a transmitting circuit, etc., and is configured to implement the transmitting function.

Optionally, the communication device 1300 may further include one or more interface circuits 1307. The interface circuit 1307 is configured to receive code instructions and transmit them to the first processor 1301. The first processor 1301 runs the code instructions, so that the communication device 1300 can perform the method described in the above method embodiments.

In one implementation, the first processor 1301 may include a transceiver configured to implement receiving and transmitting functions. For example, the transceiver may be a transceiver circuit, an interface, or an interface circuit. The transceiver circuit, interface or interface circuit, which is configured to implement receiving and transmitting functions, may be separated, or integrated together. The above transceiver circuit, interface or interface circuit may be configured to read and write codes/data, or the above transceiver circuit, interface or interface circuit may be configured to transmit or transfer a signal.

In one implementation, the first processor 1301 may store a second computer program 1303. The second computer program 1303, when executed on the first processor 1301, enables the communication device 1300 to implement the method described in the above method embodiments. The second computer program 1303 may be hardwired into the first processor 1301. In such an implementation, the first processor 1301 may be implemented by hardware.

As used herein, the term processor may refer to one processor that performs the defined functions or a plurality of processors that collectively perform defined functions, such that the execution of the individual defined functions may be divided amongst such processors.

In one implementation, the communication device 1300 may include a circuit. The circuit may implement the functions of transmitting or receiving or communicating described in the aforementioned method embodiments. The processor and the transceiver, which are described in the present application, may be implemented on an integrated circuit (IC), an analog IC, a radio frequency integrated circuit (RFIC), a mixed-signal IC, an application specific integrated circuit (ASIC), a printed circuit board (PCB), an electronic device, and so on. The processor and the transceiver may also be manufactured by various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), and so on.

The communication device described in the above embodiments may be a network device or a user equipment. However, the scope of the communication device described in the present application is not limited to this, and the structure of the communication device may not be limited by the configuration shown in FIG. 13. The communication device may be a stand-alone device, or part of a larger device. For example, the communication device may be:
(1) an independent integrated circuit (IC), a chip, a chip system or a subsystem;
(2) a set with one or more ICs, optionally, the set of ICs may also include storage components configured to store data and computer programs;
(3) an ASIC, such as a modem;
(4) a module that can be embedded in other devices;
(5) a receiver, a terminal, a smart terminal, a cellular phone, a wireless device, a handset, a mobile unit, a vehicle-mounted device, a network device, a cloud device, an artificial intelligence device and so on;
(6) others, and so on.

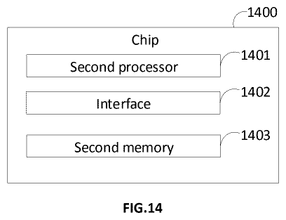

For the case where the communication device may be the chip or the chip system, reference may be made to the structural schematic diagram of the chip shown in FIG. 14. The chip 1400 shown in FIG. 14 includes a second processor 1401 and an interface 1402, where one or two second processor(s) 1401 may be provided, and a plurality of interfaces 1402 may be provided.

Optionally, the chip 1400 further includes a second memory 1403 configured to store needful computer programs and data.

Those skilled in the art may also understand that various illustrative logical blocks and steps listed in the embodiments of the present application may be implemented through electronic hardware, computer software, or a combination of both. Whether such functions are implemented by hardware or software depends on the specific application and the design requirements of the entire system. Those skilled in the art may implement the functions by using various methods for each specific application, but such implementation could not be understood as exceeding the protection scope of the embodiments of the present application.

The present application also provides a non-transitory readable storage medium storing instructions. The instructions, when executed by a computer, implements the functions of any one of the above method embodiments.

The present application also provides a computer program product. The computer program product, when executed by a computer, implements the functions of any one of the above method embodiments.

In the above embodiments, the implementation may be made in whole or in part through software, hardware, firmware or any combination of them. When implemented in software, the implementation may be embodied entirely or partially in the form of a computer program product. A computer program product includes one or more computer programs. When the computer program is loaded and executed on a computer, the processes or functions according to the embodiments of the present application are generated entirely or partially. The computer may be a general computer, a dedicated computer, a computer network, or other programmable devices. The computer program may be stored in a non-transitory computer-readable storage medium, or transferred from one non-transitory computer-readable storage medium to another. For example, the computer program may be transmitted from a website site, a computer, a server or a data center to another website site, another computer, another server or another data center by wired (such as a coaxial cable, an optical fiber and a digital subscriber line (DSL)) or wireless (such as infrared, radio or microwave) means. The non-transitory computer-readable storage medium may be any available medium that computers can access, or a data storage device such as server or data center that integrates one or more available medium. The available medium may be a magnetic medium (e.g., a floppy disk, a hard disk or a magnetic tape), an optical medium (e.g., a high-density digital video disc (DVD)), or a semiconductor medium (e.g., a solid state disk (SSD)) and so on.

Those ordinary skilled in the art may understand that the numerical numbers such as “first,” “second” and the like involved in the present application are merely used to distinguish for the convenience of description and indicate the sequential order, while could not be constructed as limiting the scope of the embodiments of the present application.

The term “at least one” may alternatively be expressed as one or more, and “a plurality” may refer to two, three, four or more, which is not limited by the present application. In the embodiments of the present application, technical characteristics in a certain technical feature are distinguished by using terms such as “first,” “second,” “third,” “A,” “B,” “C” or “D,” and these characteristics described as “first,” “second,” “third,” “A,” “B,” “C” or “D” are not constrained by any sequential or hierarchical order.

As used here, the terms “machine-readable medium” and “computer-readable medium” refer to any computer program product, device, and/or apparatus (e.g., a magnetic disk, an optical disk, a memory, a programmable logic device (PLD)) configured to provide machine instructions and/or data for a programmable processor, including a machine-readable medium that receive machine instructions in the form of machine-readable signals. The term “machine-readable signal” refers to any signal configured to provide the machine instructions and/or data for the programmable processor.

The systems and technologies described here may be implemented in a computing system that includes a back-end component (e.g., as a data server), or a computing system that includes a middleware component (e.g., an application server), or a computing system that includes a front-end component (e.g., a user computer with a graphical user interface or a web browser through which a user can interact with the implementations of the systems and technologies described here), or a computing system that includes any combination of the back-end component, the middleware component, or the front-end component. The components of the system may be interconnected via digital data communication of any form or medium (e.g., a communication network). Examples of such communication networks include local area network (LAN), wide area network (WAN) and Internet.

The computer system may include a client and a server. The client and the server are generally distal from each other and usually interact through a communication network. The relationship between the client and the server is established by respective computer programs running on each corresponding computer and having a client-server relationship with each other.

It needs to be understood that various process flows described above may be adapted through steps of reordering, adding or deleting. For example, the steps disclosed in the present disclosure may be executed in parallel, sequentially or in a different order, provided that the desired results of the technical solution disclosed in the present disclosure can be achieved, which is not limited here.

In addition, it needs to be understood that various embodiments of the present application may be implemented separately, or combined with other embodiments where the solution is feasible.

Those ordinary skilled in the art may notice that the units and algorithmic steps of each example described in connection with the embodiments disclosed here may be implemented through electronic hardware, or a combination of computer software and electronic hardware. Whether these functions are implemented through hardware or software depends on the specific application and the design constraints of the technical solution. Skilled ones may implement the described functions by using a different method for each specific application, but such implementation could not be considered as exceeding the scope of the present application.

Those skilled in the art may readily understand that for the convenience and conciseness of description, the detailed working processes of the systems, devices and units described above may refer to the corresponding processes in the aforementioned method embodiments, which is not be redundantly elaborated here.

The foregoing descriptions merely represent specific implementation of the present application, but the protection scope of the present application is not limited to this. Any modifications or substitutions, which are readily conceivable by those skilled in the art, within the technical scope disclosed by the present application, could fall within the protection scope of the present application. Consequently, the protection scope of the present application needs to be defined by the protection scope of the appended claims.

1. A method for determining a precoding codebook, performed by a network device, the method comprising:
determining a first codebook for data transmission, wherein the first codebook is generated based on channel information of at least one terminal; and
sending first codebook information of the first codebook to the at least one terminal.

2. The method according to claim 1, wherein determining the first codebook for the data transmission comprises:
receiving second codebook information sent by the at least one terminal, wherein the second codebook information is codebook information of a second codebook; and
determining the first codebook according to the second codebook information.

3. The method according to claim 2, wherein the second codebook information includes at least one of the following:
all codewords in the second codebook; or
information of a change in the codewords in the second codebook compared with codewords in the second codebook before updating; or
wherein determining the first codebook according to the second codebook information comprises:
merging all the codewords in the second codebook; and
obtaining the first codebook by deduplicating all the merged codewords.

4. (canceled)

5. The method according to claim 1, wherein determining the first codebook for the data transmission comprises:
obtaining an initial codebook;
receiving first channel information sent by the at least one terminal;
obtaining second channel information by merging the first channel information; and
determining the first codebook according to the initial codebook and the second channel information; or
wherein determining the first codebook for the data transmission comprises:
obtaining the initial codebook;
obtaining third channel information of the at least one terminal via channel estimation;
obtaining fourth channel information by merging the third channel information; and
determining the first codebook according to the initial codebook and the fourth channel information.

6. The method according to claim 5, wherein determining the first codebook according to the initial codebook and the second channel information comprises:
grouping the second channel information based on a preset optimization criterion, wherein a number of channel information groups is equal to a number of codewords in the initial codebook;
mapping a channel information group with a first codeword in the initial codebook;
obtaining an optimal precoding matrix corresponding to each channel information group according to a same rule;
determining a codeword synthesized from optimal precoding matrices for each channel information group as a second codeword for each channel information group;
replacing the mapped first codeword with the second codeword for each channel information group; and
iteratively repeating the listed steps, until the first codeword corresponding to each channel information group no longer changes, and determining a codebook with the first codeword that no longer changes for each channel information group as the first codebook; or
wherein determining the first codebook according to the initial codebook and the fourth channel information comprises:
grouping the fourth channel information based on the preset optimization criterion, wherein the number of channel information groups is equal to the number of codewords in the initial codebook;
mapping the channel information group with the first codeword in the initial codebook;
obtaining the optimal precoding matrix corresponding to each channel information group, according to the same rule;
determining the codeword synthesized from the optimal precoding matrices for each channel information group as the second codeword for each channel information group;
replacing the mapped first codeword with the second codeword for each channel information group; and
iteratively repeating the listed steps, until the first codeword corresponding to each channel information group no longer changes, and determining the codebook with the first codeword that no longer changes for each channel information group as the first codebook.

7-8. (canceled)

9. The method according to claim 5, wherein obtaining the initial codebook comprises:
generating the initial codebook randomly; or
obtaining the initial codebook at an equal interval from a multi-dimensional vector space.

10. The method according to claim 6, wherein determining the codeword synthesized from optimal precoding matrices for each channel information group as the second codeword for each channel information group comprises:
calculating a weighted average value of the optimal precoding matrices for each channel information group, and determining the synthesized codeword as the second codeword for each channel information group.

11. The method according to claim 1, wherein the first codebook information comprises at least one of the following:
all codewords in the first codebook; or
information of a change in the codewords in the first codebook compared with codewords in the first codebook before updating.

12. The method according to claim 1, further comprising:
receiving indication information of a precoding matrix sent by the at least one terminal;
determining a precoding matrix for the data transmission according to the indication information of the precoding matrix; and
sending at least one of data or a reference signal to the at least one terminal by using the precoding matrix.

13. The method according to claim 12, wherein the indication information comprises:
index information of a third codeword for the data transmission in the first codebook; or
wherein determining the precoding matrix for the data transmission according to the indication information of the precoding matrix comprises:
determining a precoding matrix corresponding to the index information in the first codebook as a precoding matrix for transmitting data.

14. (canceled)

15. A method for determining a precoding codebook, performed by a terminal, the method comprising:
receiving first codebook information sent by a network device, wherein the first codebook information is codebook information of a first codebook for data transmission, and the first codebook is generated based on channel information of at least one terminal.

16. The method according to claim 15, wherein the first codebook information includes at least one of the following:
all codewords in the first codebook; or
information of a change in the codewords in the first codebook compared with codewords in the first codebook before updating.

17. The method according to claim 15, further comprising:
obtaining an initial codebook;
obtaining first channel information; and
determining a second codebook according to the initial codebook and the first channel information.

18. The method according to claim 17, wherein obtaining the initial codebook comprises:
generating the initial codebook randomly; or
obtaining the initial codebook at an equal interval from a multi-dimensional vector space; or
wherein obtaining the first channel information comprises:
obtaining the first channel information via channel estimation; or
wherein determining the second codebook according to the initial codebook and the first channel information comprises:
grouping the first channel information based on a preset optimization criterion, wherein a number of channel information groups is equal to a number of codewords in the initial codebook;
mapping a channel information group with a first codeword in the initial codebook;
obtaining an optimal precoding matrix corresponding to each channel information group, according to a same rule;
determining a codeword synthesized from optimal precoding matrices for each channel information group as a second codeword for each channel information group;
replacing the mapped first codeword with the second codeword for each channel information group; and
iteratively repeating the listed steps, until the first codeword corresponding to each channel information group no longer changes, and
determining a codebook with the first codeword that no longer changes for each channel information group as the second codebook.

19-20. (canceled)

21. The method according to claim 18, wherein determining the codeword synthesized from the optimal precoding matrices for each channel information group as the second codeword for each channel information group comprises:
calculating a weighted average value of the optimal precoding matrices for each channel information group, and determining the synthesized codeword as the second codeword for each channel information group.

22. The method according to claim 17, further comprising:
sending second codebook information to the network device, wherein the second codebook information is codebook information of the second codebook; or
wherein the second codebook information includes at least one of the following:
all codewords in the second codebook; or
information of a change in the codewords in the second codebook compared with codewords in the second codebook before updating.

23. (canceled)

24. The method according to claim 15, further comprising:
sending first channel information to the network device; or
further comprising:
determining a precoding matrix for the data transmission according to the first codebook information and first channel information; and
sending indication information of the precoding matrix to the network device.

25. (canceled)

26. The method according to claim 24, wherein determining the precoding matrix for the data transmission according to the first codebook information and the first channel information comprises:
selecting a third codeword for the data transmission that matches the first channel information from the first codebook; and
determining a precoding matrix corresponding to the third codeword as the precoding matrix for the data transmission.

27-29. (canceled)

30. A communication device, comprising:
a memory configured to store a computer program; and
one or more processors;
wherein the computer program, when collectively executed by the one or more processors, causes the communication device to:
receive first codebook information sent by a network device, wherein the first codebook information is codebook information of a first codebook for data transmission, and the first codebook is generated based on channel information of at least one terminal.

31-32. (canceled)

33. A communication device, comprising:
a memory configured to store a computer program; and
one or more processors;
wherein the computer program, when collectively executed by the one or more processors, causes the communication device to perform the method according to claim 1.
